(19) United States
(12) Patent Application Publication
(10) Pub. No.: US 2026/0145733 A1
(43) Pub. Date: May 28, 2026

(54) AUTO-BLEEDER BI-DIRECTIONAL VALVE TO AVOID HARD STEERING ISSUE IN A HYDRAULIC POWER STEERING GEAR

(71) Applicant: ZF Active Safety and Electronics US LLC, Livonia, MI (US)

(72) Inventors: Naufil HANIFA, Coimbatore (IN); Senthil DORAI RAJ, Chennai (IN); Mayo OLASUBULUMI, West Lafayette, IN (US); Benjamin SCHOON, Lafayette, IN (US)

(21) Appl. No.: 18/956,029

(22) Filed: Nov. 22, 2024

(51) Int. Cl. B62D 5/12; B62D 5/06; F15B 13/04

(52) U.S. Cl. CPC B62D 5/12; B62D 5/062; F15B 13/0401

(57) ABSTRACT

A rack piston of a hydraulic steering assembly divides a hollow portion of a housing into an upper cylinder above the rack piston and a lower cylinder below the rack piston. The rack piston defines a rack cavity. An auto-bleeder bi-directional flow valve disposed in the rack piston allows for the flow of air and hydraulic fluid in and out of the rack cavity. The bi-directional flow valve defines a flow path through the rack piston between the rack cavity and the upper cylinder. When a differential pressure between the upper cylinder and the lower cylinder is greater than a threshold, the steel ball blocks the flow path by compressing a first spring or a second spring. Alternatively, the first spring and the second spring hold the steel ball in a neutral position to allow for the flow of air and hydraulic fluid in and out of the rack cavity.

The present disclosure relates to a hydraulic power steering gear.

### BACKGROUND

In vehicular steering systems, the rack piston is a key component in steering mechanisms, which convert the rotational motion of the steering wheel into the linear motion required to turn the vehicle's wheels. Rack pistons may be manufactured by machining a solid piece of metal, typically a cylindrical bar of alloy steel. Such rack pistons are also known as bar stock pistons. Alternatively, rack pistons may be forged by shaping a metal by applying compressive forces, often with a hammer or a press, typically when the metal is heated to a high temperature. Such rack pistons are known as forged rack pistons. The forging process compacts the metal's internal grain structure, aligning it along the shape of the piston, which enhances its mechanical properties. Forged rack pistons are generally stronger and more durable than those made from machining. The forging process results in a denser and more consistent grain structure, which improves the piston's resistance to fatigue and wear. This makes forged pistons ideal for high-stress applications where durability and strength are critical. Switching from bar stock pistons to forged rack pistons can offer significant benefits, particularly in terms of strength, durability, and performance.

However, the design of the forged rack pistons can introduce an air pocket to form in some gear orientations, which causes a hard steering effect when the air isn't bled fully at the assembly plants. Fixing this issue at the time of assembly of vehicles requires an expensive change in housing casting tooling.

### SUMMARY

Embodiments of the present disclosure provide, in a first aspect, a hydraulic steering assembly for a vehicle, comprising: a housing including a substantially cylindrical portion extending in an axial direction; a forged rack piston disposed in the hollow portion, defining a cavity extending in the axial direction, and having a first plurality of gear teeth in a bottom section of the rack that engage with a second plurality of teeth of a sector shaft, wherein the forged rack piston divides the hollow portion in to an upper cylinder above the forged rack piston and a lower cylinder below the forged rack piston and the forged rack piston defines a rack cavity, an auto-bleeder bi-directional flow valve disposed in the forged rack piston and configured to allow for flow of air and hydraulic fluid in and out of the rack cavity, wherein the auto-bleeder bi-directional flow valve defines a flow path through the forged rack piston between the rack cavity and the upper cylinder, and having a steel ball disposed in the flow path between a first spring and a second spring, such that when a differential pressure between the upper cylinder and the lower cylinder is greater than a predetermined threshold, the steel ball blocks the flow path by compressing the first spring or the second spring, and wherein when the differential pressure between the upper cylinder and the lower cylinder is less than a predetermined threshold, the first spring and the second spring hold the steel ball in a neutral position to allow for the flow of air and hydraulic fluid in and out of the rack cavity.

According to an implementation of the first aspect, the auto-bleeder bi-directional flow valve comprises a housing, and wherein the flow path runs along a length of the housing from a first end of the housing to a second end of the housing.

According to an implementation of the first aspect, the flow path comprises: a lower portion that houses the first spring; an upper position that houses the second spring; and a central portion that houses the steel ball.

According to an implementation of the first aspect, the lower portion of the flow path connects to a conduit that runs through a body of the forged rack piston, and wherein the upper portion of the flow path opens into the upper cylinder.

According to an implementation of the first aspect, the lower portion of the flow path has a first diameter that is approximately equal to a second diameter of the upper portion.

According to an implementation of the first aspect, the central portion of the flow path has third diameter that is greater than the first diameter of the lower portion and the second diameter of the upper portion.

According to an implementation of the first aspect, based on receiving a steering command from a user at a steering wheel, hydraulic fluid is directed to the upper cylinder, the second spring exerts a first force on the steel ball that is greater than a second force exerted on the steel ball by the first spring, and the steel ball blocks the lower portion of the flow path.

According to an implementation of the first aspect, based on receiving a steering command from a user at a steering wheel, hydraulic fluid is directed to the lower cylinder, the first spring exerts a first force on the steel ball that is greater than a second force exerted on the steel ball by the second spring, and the steel ball blocks the upper portion of the flow path.

According to an implementation of the first aspect, the predetermined threshold is ten (10) bar.

According to an implementation of the first aspect, the forged rack piston is generated by applying compressive forces to shape a metal when the metal is heated to a high temperature.

According to an implementation of the first aspect, the compressive forces are applied by a hammer or a press.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a perspective view of a steering gear at problematic orientation along with an auto-bleeder bi-directional flow valve, according to one or more examples of the present disclosure;

FIG. 2 illustrates the auto-bleeder bi-directional flow valve, according to one or more examples of the present disclosure;

FIGS. 3A-3B illustrates operation of the auto-bleeder bi-directional flow valve in the rack piston at a neutral position, according to one or more examples of the present disclosure;

FIGS. 4A-4B illustrates operation of the auto-bleeder bi-directional flow valve in the rack piston pressurized by the upper cylinder, according to one or more examples of the present disclosure; and

FIGS. 5A-5B illustrates operation of the auto-bleeder bi-directional flow valve in the rack piston pressurized by the lower cylinder, according to one or more examples of the present disclosure.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Steering commands received from a driver of a vehicle at the steering wheel are converted to steering motions of the wheels of the vehicle using a hydraulic steering gear. A rack piston is a key component in the hydraulic steering gear that helps to convert the rotational input received at the input shaft from the driver at the steering wheel into linear motion using hydraulic function and rack gear mechanism required to turn the wheels of the vehicle. The rack piston is equipped with teeth along one side. The teeth on one side of the rack piston engage with corresponding teeth on a sector shaft. As the rack piston moves linearly, it causes the sector shaft to rotate in a corresponding direction. For example, if the rack piston moves to the right, the sector shaft rotates in one direction, and if the rack piston moves to the left, the sector shaft rotates in an opposite direction. The rotation of the sector shaft is then transferred to the wheel assemblies of the vehicle through the output shaft and pitman arm. The pitman arm is connected to a drag link (or center link) and tie rods, which ultimately cause the wheels to turn. The direction and amount of wheel turn depend on the extent of the movement of the rack piston and the corresponding rotation of the sector shaft.

Hydraulic assistance makes the process of turning the vehicle easier and more responsive. For example, the hydraulic assistance significantly reduces the physical effort required to steer the vehicle, especially at low speeds or during parking maneuvers. Hydraulic assistance in steering also provides a more responsive and controlled steering feel, as the hydraulic pressure may be modulated to match the steering input provided by the driver to the steering wheel and road conditions.

The rotation of the steering wheel performed by the driver causes an axial rotation of a shaft within the steering column in a corresponding direction. A mechanical coupling between the shaft of the steering column and the input shaft of steering gear causes the translational movement of the rack piston through worm shaft and torsion bar within a housing that houses the rack piston and sector shaft. The rotation of the steering column shaft also triggers in-flow of a pressurized hydraulic fluid into the housing. A control valve of the hydraulic assistance unit of the hydraulic steering gear directs the pressurized hydraulic fluid to one side of the rack piston, depending on the direction of rotation of the steering column based on a rotation of the steering wheel. For example, when the steering wheel is turned right, the rotation of the steering wheel may cause the steering column shaft to rotate in a clockwise direction, which may cause the control valve to direct the pressurized hydraulic fluid either to a left side or a right side of the rack piston with respect to hand of internal helix. The accumulation of pressurized hydraulic fluid on the left side or right side of the rack piston with respect to hand of internal helix will tend to push the rack piston to the right or left causing the sector shaft to rotate in corresponding directions, which eventually causes the wheels of the vehicle to move in a corresponding direction.

Alternatively, when the steering wheel is turned left, the rotation of the steering wheel causes the steering column shaft to rotate in an anti-clockwise direction, which causes the control valve to direct the pressurized hydraulic fluid either to a right side or a left side of the rack piston with respect to hand of internal helix. The accumulation of pressurized hydraulic fluid on the right side or left side of the rack piston assists movement of the rack piston to the left or right with respect to hand of internal helix causing the sector shaft to rotate in a corresponding direction, which eventually causes the wheels to move in the in the corresponding direction.

Conventionally, bar stock rack pistons were used in hydraulic steering system. Bar stock pistons were designed from a solid piece of metal, typically a cylindrical bar of alloy steel. Recently, the designing of rack pistons used in hydraulic steering systems has transitioned from bar stock rack pistons to forged rack pistons. The forged rack pistons are designed by shaping the metal by applying compressive forces, often with a hammer or a press, typically when the metal is heated to a high temperature. The forging process compacts the metal's internal grain structure, aligning it along the shape of the piston, which enhances its mechanical properties. Forged rack pistons are significantly stronger than bar stock pistons due to the forging process, which realigns the metal's grain structure to follow the shape of the piston. This results in improved tensile strength and resistance to impact and stress, making the steering system more robust, especially in demanding conditions. The denser and more uniform grain structure in forged pistons leads to better wear resistance and longer lifespan. Forged rack pistons are also more durable than bar stock pistons, which is particularly beneficial in vehicles that are subject to heavy use, such as trucks, off-road vehicles, or performance cars, where steering components are regularly exposed to high loads and harsh conditions. The enhanced strength and durability of forged rack pistons contribute to more precise and responsive steering. This is particularly important in high-performance vehicles where steering accuracy is critical. The improved performance can lead to better vehicle handling and driver control.

However, the design of the forged rack pistons potentially introduces an air pocket to form in some orientations, which causes a hard steering effect when air isn't bled fully from the forged rack piston at the vehicle assembly plants. Fixing this issue at the time of assembly of vehicles requires an expensive change in housing casting tooling. Additionally, designing a new housing for to accommodate the new design of the forged rack piston will require extensive development, validation efforts, and resources.

The present disclosure provides a new design of a forged rack piston with a bi-directional flow valve that may reduce the hard steering effect introduced in the hydraulic steering systems.

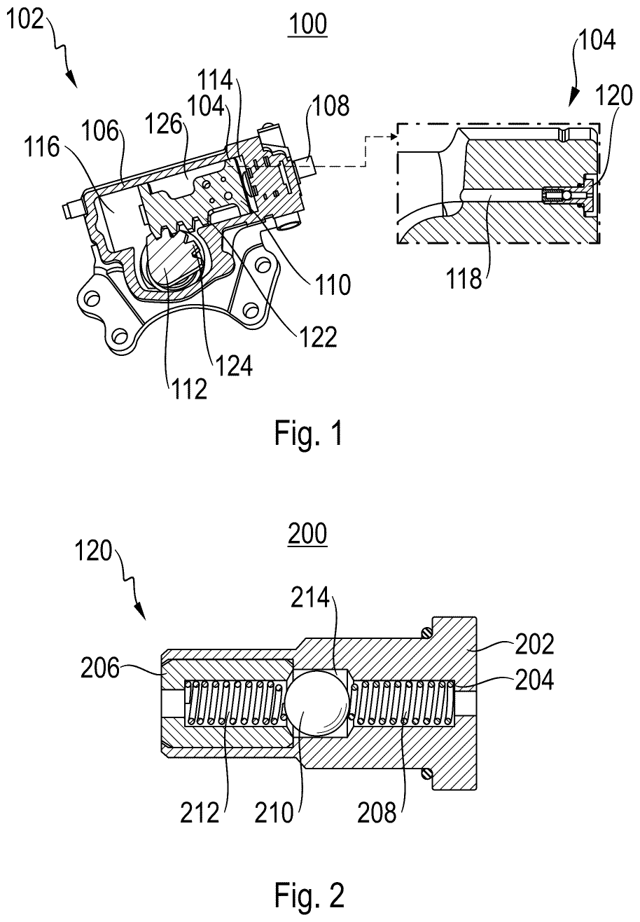

FIG. 1 illustrates a perspective view of a steering gear at a problematic orientation along with an auto-bleeder bi-directional flow valve, according to one or more examples of the present disclosure. Perspective 100 of FIG. 1 depicts a cross-section view of a hydraulic steering gear 102. The hydraulic steering gear 102 is connected to a steering wheel of a vehicle by way of an input shaft 108. The input shaft 108 may be connected to a steering column shaft that is connected to a steering wheel. The steering command provided by a driver at the steering wheel of the vehicle may be transmitted to the wheels of the vehicles via the hydraulic steering gear 102. The hydraulic steering gear 102 includes a housing 106 with a hollow portion that houses a rack piston 110 (e.g., a forged rack piston 110) and a sector shaft 112. The rack piston has a set of teeth 122 that engage with a second set of teeth 124 on the sector shaft 112. The rack piston 110 divides the hollow portion of the housing 106 into an upper cylinder 114 and a lower cylinder 116. The upper cylinder 114 and the lower cylinder 116 may be separated using a sealing ring.

A hydraulic assistance unit may be used as part of the hydraulic steering gear to make the steering process easier for the driver of the vehicle. The hydraulic assistance unit may comprise a pressure line that is used to supply pressurized hydraulic fluid to the housing 106 of the hydraulic steering gear 102. The hydraulic assistance unit of the hydraulic steering gear 106 may also include a return line that may be used to remove the pressurized hydraulic fluid from the housing 106 of the hydraulic steering gear 102. The hydraulic assistance unit may include a control valve to direct pressurized hydraulic fluid to one side of the rack piston, depending on the direction of rotation of the steering column shaft based on a rotation of the steering wheel.

In some embodiments, the rotation of the steering wheel of the vehicle may cause the rotation of the steering column shaft in a corresponding direction, which causes a rotation of the input shaft 108 in a similar direction. For example, when the steering wheel is turned right, the rotation of the steering wheel may cause the steering column shaft to rotate in a clockwise direction and the rotation of the steering column shaft in the clockwise direction may cause the rotation of the input shaft 108 in the clockwise direction. The rotation of the input shaft 108 in the clockwise direction may cause the control valve to direct pressurized hydraulic fluid either to the upper cylinder 114 or the lower cylinder 116 of the rack piston 110 with respect to hand of internal helix. The accumulation of pressurized hydraulic fluid on the upper cylinder 114 or lower cylinder 116 of the rack piston 110 with respect to hand of internal helix tends to push the rack piston 110 to the right or left, causes the sector shaft 112 to rotate a corresponding direction, which eventually causes the wheels of the vehicle to move in the corresponding direction.

Alternatively, when the steering wheel is turned left, the rotation of the steering wheel causes the steering column shaft to rotate in an anti-clockwise direction, which causes the rotation of the input shaft in the anti-clockwise direction. The rotation of the input shaft 108 in the anti-clockwise direction may cause the control valve to direct pressurized hydraulic fluid either to the lower cylinder 116 or upper cylinder 114 of the rack piston 110 with respect to hand of internal helix. The accumulation of pressurized hydraulic fluid on the lower cylinder 116 or upper cylinder 114 of the rack piston 110 with respect to hand of internal helix tends to push the rack piston 110 to the left or the right, causes the sector shaft 112 to rotate a corresponding direction, eventually causing the wheels of the vehicle to move in the corresponding direction.

The accumulation of pressurized hydraulic fluid in either the upper cylinder 114 or the lower cylinder 116 may create a pressure differential between the upper cylinder 114 and the lower cylinder 116.

In some embodiments, repeated motion of the rack piston 110 in the right and left direction may lead to air being trapped in the upper cylinder 114 or the cavity 126 between the upper cylinder 114 and the lower cylinder 116. The air entrapments in the upper cylinder 114 or the cavity 126 may cause a hard steering effect.

An auto-bleeder bi-directional flow valve 120 is installed at location 104 of the rack piston 110 in order to facilitate automatic bleeding of air and pressurized hydraulic fluid in and out of the rack piston 110 and the upper cylinder 114. Location 104 may be at an upper face of the rack piston 110 as shown in FIG. 1. The location 104 may include a conduit 118 that runs through the body of the rack piston 110. A lower end of the conduit 118 in the body of the rack piston 110 may open into the cavity 126 between the upper cylinder 114 and the lower cylinder 116 and an upper end of the conduit 118 may open in the upper cylinder 114. A bi-directional flow valve 120 may be inserted at the upper end of the conduit 118 created within the body of the rack piston 110. A first end of the bi-directional flow valve connects with the upper end of the conduit 118 and a second end of the bi-directional flow valve 120 connects to cavity 126. The design of the bi-directional flow valve 120 is described in more detail with respect to FIG. 2.

FIG. 2 illustrates a cross-sectional view of the auto-bleeder bi-directional flow valve, according to one or more examples of the present disclosure. The bi-directional flow valve 120 includes a housing 202. The housing 202 includes a flow path that runs through the housing 202. The flow path may be divided into three parts, a lower portion 206, a central portion 214, and an upper portion 204. The lower portion 206 connects to the conduit 118 in the body of the rack piston 110. The upper portion 204 of the flow path may be connected to the environment outside the rack piston 110. In some embodiments, the environment outside the rack piston 110 may include the upper cylinder 114. A lower spring 212 may be included in the lower portion 206 of the flow path of the bi-directional flow valve 120. The compressed length of the lower spring 212 may be the length of the lower portion 206 of the flow path of the bi-directional flow valve 120. Similarly, an upper spring 208 may be included in the upper portion 204 of the flow path of the bi-directional flow valve 120. The compressed length of the upper spring 208 may be the length of the upper portion 204 of the flow path of the bi-directional flow valve 120.

A central portion 214 of the flow path through the bi-directional flow valve 120 may connect the lower portion 206 of the flow path to the upper portion 204 of the flow path. In some embodiments, the central portion 214 of the flow path may be wider in diameter than the diameters of the lower portion 206 and the upper portion 204 of the flow path. In some embodiments, the diameters of the lower portion 206 and the upper portion 204 of the flow path may be equal.

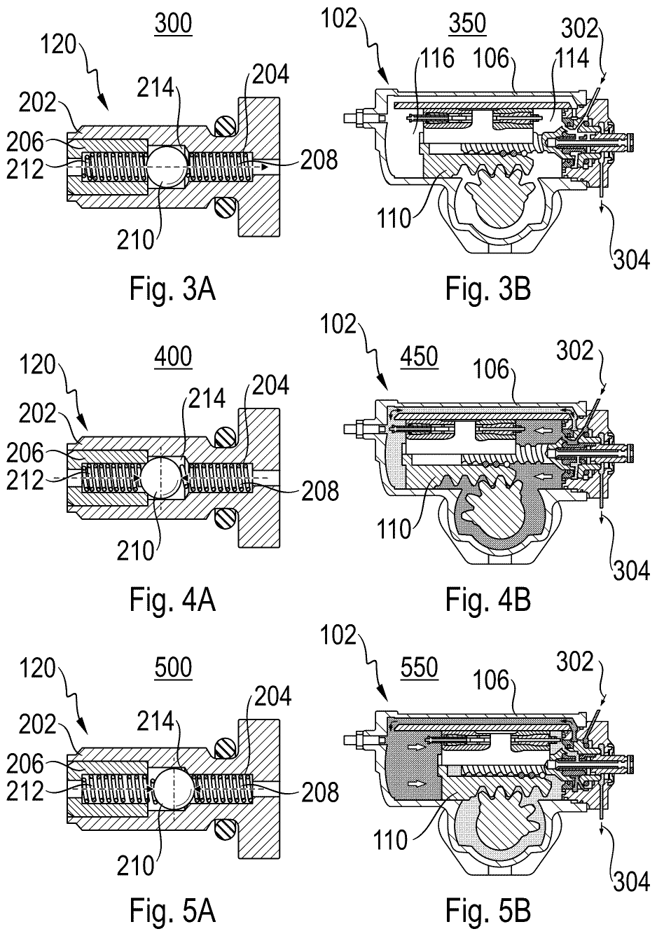

A precision steel ball 210 may be housed in the central portion 214 of the flow path. In case when no steering command is applied to the steering wheel by a driver, there may be almost no pressure differential between the upper cylinder 114 (shown in FIG. 1) and lower cylinder 116 (shown in FIG. 1) of the steering gear 102 (shown in FIG. 1). In such a case, the upper spring 212 and lower spring 208 may apply a force on the steel ball to keep the steel ball 210 centered in a neutral position in the central portion 214 of the flow path. When the steel ball 210 is centered in a neutral position in the central portion 214 of the flow path in the bi-directional flow valve 120, air and pressurized hydraulic fluid may flow out of the cavity 126 (shown in FIG. 1) within the rack piston 110 (shown in FIG. 1) of the steering gear 102. This operation is described in more detail with respect to FIGS. 3A and 3B.

Alternatively, in case when a steering command is applied to the steering wheel by the driver, the pressure differential between the upper cylinder 114 and the lower cylinder 116 may be greater than a predetermined threshold. In such cases, one of the upper spring 208 or the lower spring 212 may apply extra force on the steel ball 210 to block either the upper portion 204 of the flow path or the lower portion 206 of the flow path of the bi-directional flow valve 120. When lower spring 212 applies greater pressure, the steel ball 210 is pushed towards the upper portion 204 of the flow path to block the upper portion 204 of the flow path. Alternatively, when upper spring 208 applies greater pressure, the steel ball 210 is pushed towards the lower portion 206 of the flow path to block the lower portion 204 of the flow path. In either case, the flow path through the bi-directional flow valve 120 is blocked, air and pressurized hydraulic fluid may not flow out of the cavity 126 (shown in FIG. 1) within the rack piston 110 (shown in FIG. 1) of the steering gear 102. These operations are described in more detail with respect to FIGS. 4A-4B and 5A-5B.

FIGS. 3A and 3B illustrate operation of the auto-bleeder bi-directional flow valve in the rack piston at a neutral position i.e., when both cylinders pressurized, according to one or more examples of the present disclosure. FIG. 3A depicts a cross-sectional view 300 of the bi-directional flow valve 120 when no steering action is performed. FIG. 3B depicts a cross-sectional view 350 of the steering gear 102 when no steering action is performed. The cross-sectional view 350 of the steering gear 102 depicts the upper cylinder 114 and the lower cylinder 116. A pressure line 302 provides pressurized hydraulic fluid to the housing 106 of the steering gear 102. A return line 304 removes pressurized hydraulic fluid from the housing 106 of the steering gear 102. A control valve controls the direction of the pressurized fluid from the pressure line 302. In some embodiments, when no steering action is performed on the steering wheel, pressurized hydraulic fluid is not introduced into the housing 106 via the pressure line 302. In such a case, the pressure difference between the upper cylinder 114 and the lower cylinder 116 may be less than a predetermined threshold. For example, the predetermined threshold may be ten (10) bar. While the pressure differential between the upper cylinder 114 and the lower cylinder 116 is less than the predetermined threshold (e.g., 10 bar), the steel ball 210, as shown in FIG. 3A, may be kept centered in a neutral position in the central portion 214 of the flow path in the bi-directional flow valve 120 by the force applied by the upper spring 212 and lower spring 208. When the steel ball 210 is centered in the central portion 214 of the flow path in the bi-directional flow valve 120, air and pressurized hydraulic fluid may flow out of the cavity 126 (shown in FIG. 1) within the rack piston 110 (shown in FIG. 1) of the steering gear 102 via the lower portion 206 of the flow path and the upper portion 204 of the flow path.

FIGS. 4A and 4B illustrates operation of the auto-bleeder bi-directional flow valve 120 in the rack piston 110 pressurized by the upper cylinder, according to one or more examples of the present disclosure. FIG. 4A depicts a cross-sectional view 400 of the bi-directional flow valve 120 when a steering action is performed. FIG. 4B depicts a cross-sectional view 350 of the steering gear 102 when a steering action is performed. The cross-sectional view 450 of the steering gear 102 depicts the upper cylinder 114 and the lower cylinder 116. As described above with respect to FIGS. 3A and 3B, the pressure line 302 provides pressurized hydraulic fluid to the housing 106 of the steering gear 102, and the return line 304 removes pressurized hydraulic fluid from the housing 106 of the steering gear 102. The control valve controls the direction of the pressurized fluid from the pressure line 302. In some embodiments, when a right steering action is performed on the steering wheel, pressurized hydraulic fluid is introduced into either the upper cylinder 114 or the lower cylinder 116 with respect to hand of internal helix in rack piston via the control valve from the pressure line 302 to move the rack piston 110 towards the lower cylinder 116 or the upper cylinder 114. In such a case, the pressure difference between the upper cylinder 114 and the lower cylinder 116 may build up to be greater than the predetermined threshold (e.g., 10 bar). While the pressure differential between the upper cylinder 114 and the lower cylinder 116 is greater than the predetermined threshold (e.g., 10 bar), the steel ball 210, as shown in FIG. 4A, may close the bi-directional flow valve 120. For example, when pressure build up in the upper cylinder 114 is greater than the pressure in the lower cylinder 116, by a predetermined threshold (e.g., 10 bar), the upper spring 208 may exert a force on the steel ball 210 that is greater than the force exerted on the steel ball 210 by the lower spring 212. The difference in the force applied by the upper spring 208 and the lower spring 210 on the steel ball 210 moves the steel ball 210 towards the lower portion 206 of the flow path. This blocks the lower portion 206 of the flow path of the bi-directional flow valve 120 completely, preventing internal leakage and enabling normal operation of the steering gear with full hydraulic assist.

FIGS. 5A and 5B illustrates operation of the auto-bleeder bi-directional flow valve 120 in the rack piston 110 pressurized by the lower cylinder, according to one or more examples of the present disclosure. FIG. 5A depicts a cross-sectional view 400 of the bi-directional flow valve 120 when a steering action is performed. FIG. 5B depicts a cross-sectional view 350 of the steering gear 102 when a steering action is performed. The cross-sectional view 550 of the steering gear 102 is partially similar to the cross-sectional view 100 of the steering gear 102 as shown in FIG. 1. The cross-sectional view 550 of the steering gear 102 depicts the upper cylinder 114 and the lower cylinder 116. As described above with respect to FIGS. 3A and 3B, the pressure line 302 provides pressurized hydraulic fluid to the housing 106 of the steering gear 102, and the return line 304 removes pressurized hydraulic fluid from the housing 106 of the steering gear 102. The control valve controls the direction of the pressurized fluid from the pressure line 302. In some embodiments, when a left steering action is performed on the steering wheel, pressurized hydraulic fluid is introduced into either the lower cylinder 116 or the upper cylinder 114 with respect to hand of internal helix in rack piston via the control valve from the pressure line 302 to move the rack piston 110 to move the rack piston 110 towards the upper cylinder 114 or lower cylinder 116. In such a case, the pressure difference between the upper cylinder 114 and the lower cylinder 116 may build up to be greater than the predetermined threshold (e.g., 10 bar). While the pressure differential between the lower cylinder 114 and the upper cylinder 116 is greater than the predetermined threshold (e.g., 10 bar), the steel ball 210, as shown in FIG. 5A, may close the bi-directional flow valve 120. For example, when pressure build up in the lower cylinder 116 is greater than the pressure in the upper cylinder 114, by a predetermined threshold (e.g., 10 bar), the lower spring 212 may exert a force on the steel ball 210 that is greater than the force exerted on the steel ball 210 by the upper spring 208. The difference in the force applied by the lower spring 212 and the upper spring 208 on the steel ball 210 moves the steel ball 210 towards the upper portion 204 of the flow path. This blocks the upper portion 204 of the flow path of the bi-directional flow valve 120 completely, preventing internal leakage and enabling normal operation of the steering gear with full hydraulic assist.

In either case when the flow path through the bi-directional flow valve 120 is blocked and air and pressurized hydraulic fluid and air may not flow out of the cavity 126 (shown in FIG. 1) within the rack piston 110 (shown in FIG. 1) of the steering gear 102.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A hydraulic steering assembly for a vehicle, comprising:
a housing including a substantially cylindrical portion extending in an axial direction;
a forged rack piston disposed in the hollow portion, defining a cavity extending in the axial direction, and having a first plurality of gear teeth in a bottom section of the rack that engage with a second plurality of teeth of a sector shaft,
wherein the forged rack piston divides the hollow portion in to an upper cylinder above the forged rack piston and a lower cylinder below the forged rack piston and the forged rack piston defines a rack cavity,
an auto-bleeder bi-directional flow valve disposed in the forged rack piston and configured to allow for flow of air and hydraulic fluid in and out of the rack cavity,
wherein the auto-bleeder bi-directional flow valve defines a flow path through the forged rack piston between the rack cavity and the upper cylinder, and having a steel ball disposed in the flow path between a first spring and a second spring, such that when a differential pressure between the upper cylinder and the lower cylinder is greater than a predetermined threshold, the steel ball blocks the flow path by compressing the first spring or the second spring, and
wherein when the differential pressure between the upper cylinder and the lower cylinder is less than a predetermined threshold, the first spring and the second spring hold the steel ball in a neutral position to allow for the flow of air and hydraulic fluid in and out of the rack cavity.

2. The hydraulic steering assembly of claim 1, wherein the bi-directional flow valve comprises a housing, and wherein the flow path runs along a length of the housing from a first end of the housing to a second end of the housing.

3. The hydraulic steering assembly of claim 2, wherein the flow path comprises:
a lower portion that houses the first spring;
an upper position that houses the second spring; and
a central portion that houses the steel ball.

4. The hydraulic steering assembly of claim 3, wherein the lower portion of the flow path connects to a conduit that runs through a body of the forged rack piston, and wherein the upper portion of the flow path opens into the upper cylinder.

5. The hydraulic steering assembly of claim 3, wherein the lower portion of the flow path has a first diameter that is approximately equal to a second diameter of the upper portion.

6. The hydraulic steering assembly of claim 3, wherein the central portion of the flow path has third diameter that is greater than the first diameter of the lower portion and the second diameter of the upper portion.

7. The hydraulic steering assembly of claim 3, wherein based on receiving a steering command from a user at a steering wheel, hydraulic fluid is directed to the upper cylinder, the second spring exerts a first force on the steel ball that is greater than a second force exerted on the steel ball by the first spring, and the steel ball blocks the lower portion of the flow path.

8. The hydraulic steering assembly of claim 3, wherein based on receiving a steering command from a user at a steering wheel, hydraulic fluid is directed to the lower cylinder, the first spring exerts a first force on the steel ball that is greater than a second force exerted on the steel ball by the second spring, and the steel ball blocks the upper portion of the flow path.

9. The hydraulic steering assembly of claim 1, wherein the predetermined threshold is ten (10) bar.

10. The hydraulic steering assembly of claim 1, wherein the forged rack piston is generated by applying compressive forces to shape a metal when the metal is heated to a high temperature.

11. The hydraulic steering assembly of claim 1, wherein the compressive forces are applied by a hammer or a press.
